(19) United States
(12) Patent Application Publication
(10) Pub. No.: US 2010/0323329 A1
(43) Pub. Date: Dec. 23, 2010

(54) Apparatus and Method for Manufacturing Customized Dentures

(75) Inventors: Prasad Adusumilli, Parsippany, NJ (US); Stanley J. Lech, Parsippany, NJ (US); Zvi G. Loewy, Parsippany, NJ (US)

Correspondence Address: GlaxoSmithKline;GLOBAL PATENTS -US, UW2220, P. O. BOX 1539, KING OF PRUSSIA, PA, 19406-0939, US

(73) Assignees: SmithKline Beecham Corporation; GlaxoSmithKline LLC

(21) Appl. No.: 12/918,342

(22) PCT Filed: Feb. 20, 2009
(86) PCT No.: PCT/US09/34645

§ 371 Date: Aug. 19, 2010

Related U.S. Application Data
(60) Provisional application No. 61/030,795, filed on Feb. 22, 2008.

(51) Int. Cl. A61C 13/00

(52) U.S. Cl. 433/213

(57) ABSTRACT

This disclosure relates to an apparatus and method for digitally utilizing and customizing dental features needed in the manufacture of dentures.

### BACKGROUND OF THE INVENTION

1. Field of the Invention

The present disclosure relates to an apparatus and method for digitally utilizing and customizing dental features needed in the manufacture of dentures.

2. Description of the Related Art

Full or partial dentures are intended to be worn in the mouth to replace missing teeth. Current processes for manufacturing dentures involve multiple steps, including examining the patient, evaluating lip pull and vertical dimension, taking impressions of the oral cavity, boxing impressions, fabricating and placing an orthopedic splint, preparing custom base plates, preparing an esthetic blue print record base, preparing a neutral zone record base and a central bearing device, records, wax try-in, face bow, articulator, indexing and tooth placement, external impression, occlusion, delivery and patient follow-up.

Because this is a labor-intensive process, and has a great deal of subjective measuring and designs, the resulting denture is not user friendly and can be customized only minimally. Also, the resulting denture encounters frequent problems including sore spots, lack of hold and retention, and bacterial growth that may lead to malodor and associated health problems. Aside from these potential physical problems, the aesthetics of the denture may be compromised due to the multi-step evaluation and process.

In determining the aesthetic “look and feel” of the end-result denture, the dental practitioner typically shows the patient many images of third parties wearing different dentures and the patient selects one or more images based on their preference. This process does not provide the patient an ability to evaluate how he will appear with each of the various types of dentures.

Fitting a denture is both a mechanical process and an aesthetic determination that involves physical and emotional sensitivities. This disclosure utilizes digital technology to obtain data about the mouth and then manipulate those data to generate one or more virtual images of the patient with various dentures in place. Accordingly, the patient has an opportunity to choose various aesthetic features for his dentures, and the practitioner has an opportunity to fabricate a denture that is both mechanically and aesthetically acceptable. Since the patient is able to view himself in various configurations and selects the preferred look, the resulting prosthesis will provide much higher satisfaction.

### SUMMARY OF THE INVENTION

The present disclosure relates to an apparatus and method for manipulating one or more digital images of an edentulous patient to provide varying images of dentures viewed within the patient's mouth.

The present disclosure also relates to a method for providing a virtual image containing one or more denture shapes, within the patient's mouth, from which the patient can choose.

The present disclosure further relates to a method for providing a virtual image containing one or more tooth shapes, within the patient's mouth, from which the patient can choose.

The present disclosure still further relates to a method for providing a virtual image containing one or more tooth color, within the patient's mouth, from which the patient can choose.

The present disclosure yet further relates to a method for providing a virtual image containing one or more gum line colors, within the patient's mouth, from which the patient can choose.

### BRIEF DESCRIPTION OF THE DRAWINGS

FIG. 1 is a flow diagram of a method for capturing a patient's denture preferences.

FIG. 2 shows a patient selecting, with a user interface and an input device, options for dentures.

### DESCRIPTION OF THE DISCLOSURE

The term “denture(s)” is used herein to refer to dentures or partial dentures, artificial teeth, removable orthodontic bridges and denture plates, both upper and lower types, orthodontic retainers and appliances, protective mouthguards, nightguards to prevent bruxism and/or temporomandibular joint (TMJ) disorder, and the like. The term “lip pull” refers to the asymmetry of a patient's smile with respect to an axis; when the patient smiles, lip pull causes more teeth to show on one side of the axis than another. The term “vertical dimension” refers to a difference in the distance between given facial or oral reference points when the patient's mouth is closed and at rest position. In turn, the term “closed position” refers to the condition in which the patient's teeth are fully occluded, for example when the patient has closed his mouth.

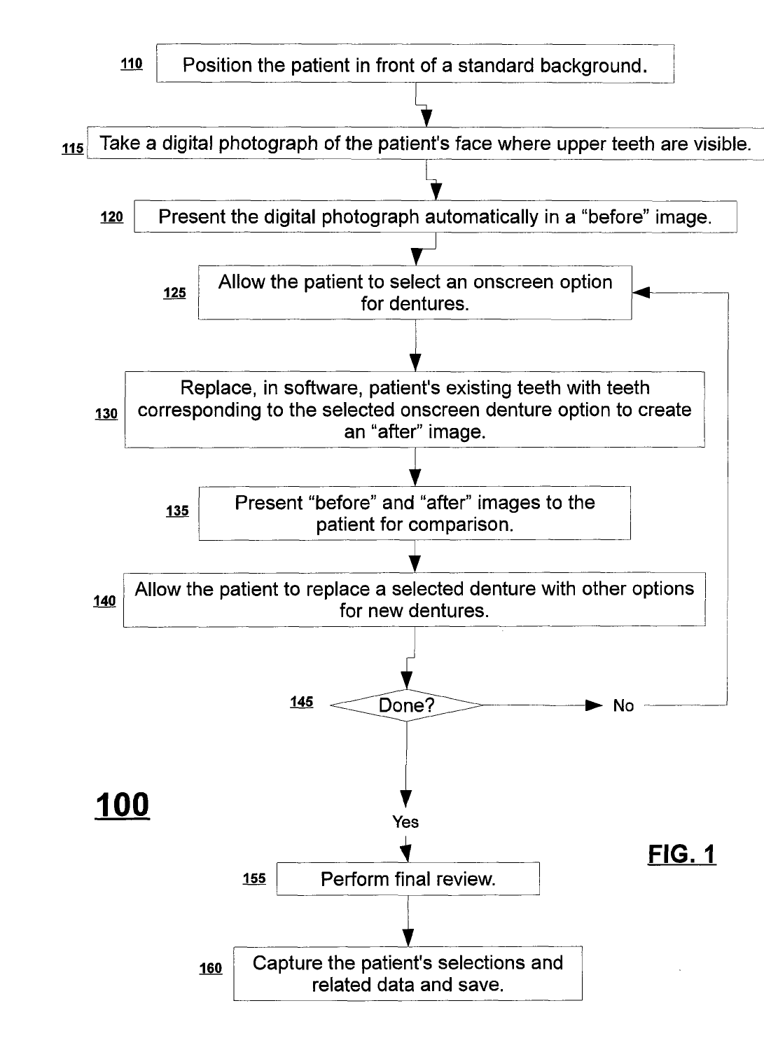

FIG. 1 is a process flow diagram of a method generally referred to as reference numeral 100 of the present disclosure. Method 100 captures a patient's denture preferences. One or more digital images of the patient are taken and provided to a software program. The digital images provide mechanical information about the shape, size, vertical dimension of the mouth, including measurements of any remaining teeth in the mouth of the edentulous patient. The program manipulates the data generated from the digital images and provides multiple images of the patient with different dentures and allows the patient to look at himself, virtually, before and after the dentures are in place. These variations include different denture shapes and sizes and different teeth and gum colors. In addition, customization of teeth placement is simulated such that the resulting denture provides the aesthetics similar to that of natural dentition.

Method 100 begins at step 110, when a patient is positioned in front of a standard background. Next, method 100 progresses to step 115, in which a digital photograph of the patient's face, with upper teeth visible, is taken. As an alternative to step 115, a pre-existing photograph of the patient may be substituted and inputted in place of a de novo digital photograph. A further alternative to step 115 is to substitute a 3-dimensional scan of the patient's face taken while the patient's teeth are visible. The digital photograph is presented on a screen or other suitable display device in step 120 as a “before” image.

In step 125, the patient is allowed to select, from a presentation screen, an onscreen desired option for his dentures from a set of options available. The options available may be related to tooth size, shape, color, color of gums, skin tone, amount of tooth show, and amount of gum show, custom variations of tooth placement patterns, buccal corridor or other personal aesthetic features. Then, at step 130, method 100 will replace, in software, the patient's existing teeth with teeth corresponding to the onscreen desired option, to create and output an “after” image. At step 135, the “before” image (of step 120) and the “after” image (of step 130) are presented to the patient for comparison.

Next, at step 140, the patient is allowed to replace a selected denture, i.e. that of the “after” image, with still further options and features. At step 145, the patient or clinician decide whether further iterations through steps 125-140 are needed. If not, then method 100 progresses to step 155.

At step 155, the patient and his clinician perform a final review of features selected by the patient in preceding steps of method 100. Method 100 next progresses to its final step 160, in which the patient's final selections and related data are captured and saved as a record. In an embodiment, the patient's selections and related data are written to an electronic record storage medium, or written to a paper record. The patient's selections form part of a prescription, based upon which a fabricator will later construct dentures for the patient.

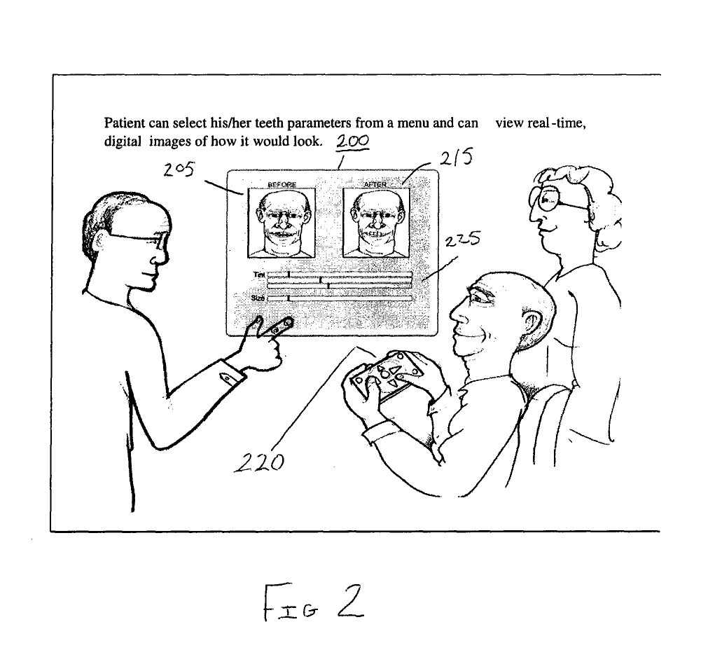

FIG. 2 shows a patient selecting options for dentures (see step 125 in FIG. 1).

The patient interacts with a user interface 200 using an input device 220. Input device 220 contains hardware, software, circuitry, or a combination thereof, for effecting connection to and communication to user interface 200.

User interface 200 provides the patient with a “before” image 205, an “after” image 215, and an option-adjusting area 225. The patient uses input device 220 to command adjustment of various options presented in option-adjusting area 225, such as tooth tint, tooth shape, gum color, and other aesthetic parameters.

In accordance with the adjustment commanded by the patient, after image 215 will take on different characteristics. For example, if the patient has commanded a lightening of tooth tint, then after image 215 will depict lighter-colored dentition. The patient is free to command adjustments until satisfied with after image 215.

Adjustments, which, in the background art, are typically made manually to vertical dimension and lip pull, are simulated digitally on user interface 200. The selected image is sent to the dental laboratory to ensure that the dental technician constructs the denture to mirror the chosen image.

The present disclosure has been described with particular reference to certain embodiments. It should be understood that the foregoing descriptions and examples are only illustrative of the invention. Various alternatives and modifications thereof can be devised by those skilled in the art without departing from the spirit and scope of the present disclosure. Accordingly, the present disclosure is intended to embrace all such alternatives, modifications, and variations that fall within the scope of the appended claims.

What is claimed is:

1. An apparatus for manipulating digital images of an edentulous patient, comprising:
an image input that accepts a first digital image of the patient;
a user interface that presents a plurality of denture options to the patient, and that receives from an input device a selection of said denture options; and
an image output that outputs a second digital image of the patient, wherein said second digital image represents dentures installed in the patient according to said selection of said denture options.

2. The apparatus of claim 1, wherein said plurality of denture options comprises denture shape, tooth size, shape and color, shape, gum color, skin tone, amount of tooth show, and amount of gum show, custom variations of tooth placement patterns, and buccal corridor.

3. A method for capturing an edentulous patient's denture preferences, comprising:
accepting a first digital image of the patient;
presenting a plurality of denture options to the patient;
receiving from an input device a selection of said denture options; and
outputting a second digital image of the patient, wherein said second digital image of the patient represents dentures installed in the patient according to said selection of said denture options.

4. The method of claim 3, wherein said plurality of denture options comprises denture shape, tooth size, shape and color, shape, gum color, skin tone, amount of tooth show, and amount of gum show, custom variations of tooth placement patterns, buccal corridor or other personal aesthetic features.

5. The method of claim 3, wherein said plurality of denture options comprises options that affect vertical dimension and lip pull.

6. The apparatus of claim 1, wherein said plurality of denture options comprises options that affect vertical dimension and lip pull.

7. The apparatus of claim 1, wherein said input device is sized and adapted to be hand-held by the patient.

8. The method of claim 3, further comprising a step of outputting the patient's selections to a storage medium.

9. The method of claim 8 wherein said storage medium is an electronic record storage medium.

10. The method of claim 8 wherein said storage medium is a paper record.

11. The method of claim 3, further comprising a step of incorporating the patient's selections to a prescription.

12. The method of claim 11, wherein a fabrication process is based upon said prescription.

13. The apparatus of claim 2, wherein said plurality of denture options further comprises other personal aesthetic features of the patient.

14. The method of claim 3, wherein said plurality of denture options further comprises other personal aesthetic features of the patient.
